(19) United States
(12) Patent Application Publication
(10) Pub. No.: US 2006/0293796 A1
(43) Pub. Date: Dec. 28, 2006

(54) Method and device for controlling movement of a large mass

(76) Inventors: Patrick C. St. Germain, Iron River, WI (US); Gerald K. Langreck, Phillips, WI (US)

Correspondence Address: OLSON & HIERL, LTD., 20 NORTH WACKER DRIVE, 36TH FLOOR, CHICAGO, IL, 60606, US

(21) Appl. No.: 11/158,770

(22) Filed: Jun. 22, 2005

(51) Int. Cl. G05B 15/00

(52) U.S. Cl. 700/260

(57) ABSTRACT

A device suitable for efficiently controlling movement of a large mass where frequent acceleration and deceleration occur and precise positioning is desired is provided. A plurality of servomotors with drive gears are engaged with a main gear. A master feedback signal based on the speed and position of the servomotors is received by a controller capable of sending individual control signals to each of the plurality of servomotors so as to adjust the speed and positioning of the large mass.

### FIELD OF THE INVENTION

The present invention relates to the field of converting equipment or more particularly paper, nonwoven, and wet or dry wiper converting machines where large masses must be positioned quickly and accurately.

### BACKGROUND OF THE INVENTION

Industrial equipment such as converting equipment tends to be of a robust or heavy nature. As such, converting machinery typically involves moving parts with large weights or masses. For example, knife or folding rolls must be made of a strong and relatively heavy material such as steel, and as roll widths increase, the diameter of the rolls must also be increased to maintain rigidity. As such, for larger applications, the increase in weight and mass for such components can be significant, which affects the ability to accelerate and decelerate, position, or otherwise profile the movement of the components.

For example, one typical application is a cutoff knife to cut desired lengths from a web of material. The knife roll diameter is commonly built to a diameter such that the circumference of the knife roll matches the cutoff length desired for the web. As such, the linear speed of the knife roll, which is constant, matches the speed of the web so that the desired cutoff length of the web is cut. In this situation, an accurate cut is achieved and the presence of large amounts of mass is not a problem.

One shortcoming, however, is that the cutoff length is limited to the one obtained with specific constant speed and diameter of the roll. In other words, only one cutoff length is made with a particular knife roll. In order to change the cutoff length possible for a particular machine, the entire knife roll must be exchanged. This process is cumbersome and requires substantial downtime to exchange components. Therefore, it is desired to have a more flexible machine that it is able to run more than one product or cutoff length.

There have been several attempts to design machinery capable of producing products of variable lengths. One mechanism utilizes a knife roll having multiple knife holders. Depending on the placement of knife blades, different cutoff lengths are possible. The shortcoming with this approach, however, is that only a finite number of cutoff lengths are possible. Also, as before, there is substantial downtime required to adjust the knife blades on the knife roll.

Another approach that has been tried to create cutoffs of varying lengths is to lip product back on the knife. In other words, by varying the linear speed of the knife roll, different cutoff lengths can be obtained. For example, an arrangement is made where the knife roll is rotated with a linear speed that is greater than the linear speed of the web. Such an arrangement creates a shorter cutoff length than would be obtained if the linear speed of the knife roll and the web were the same. Similarly, by rotating the knife roll with a linear speed that is less than the linear speed of the web, a greater cutoff length can be obtained. This method, however, experiences several drawbacks. Because of the mismatched linear speeds of the knife roll and the web, the knife blades tend to tug or pull on the product and create an undesired biased or uneven cut. The greater drawback is that the range of variability of the cutoff lengths is generally limited to only a few inches, which is insufficient to accommodate the wider variety of different products.

Developments in the field of electronics and closed loop servo motion control has led to devices of one physical size with a servomotor fitted to the end of a roll. The adjustability of the servomotor enables the specific linear speed of the roll to be profiled, i.e., accurately positioned through acceleration and deceleration, to obtain accurate and highly variable cutoff lengths. Using this method, the knife roll can be controlled to accommodate the web for a particular product and to avoid the shortcoming of a biased or uneven cut. In addition, when the knife roll is not interacting with the product, it can be profiled or accurately positioned to vary the cutoff length for the next product, and thereby decrease the amount of downtime.

While this method has been somewhat successful, it is limited in application to machinery of relatively small masses. Problems arise, however, in applications involving relatively large masses, such as with paper converting machinery. As the mass of the load to be moved and controlled increases, the servomotor needed to move the mass increases in mass as well. As this happens the controlled acceleration and deceleration achievable by the servomotor for the system suffers and performance decreases.

Another problem encountered with the use of a single servomotor in large mass applications relates to the method of coupling the mass to the motor. Typically, conventional coupling approaches result in problems with resonance, which cause inaccurate control of the system. In a tightly controlled servo loop that demands the utmost in performance rigidity of motor to load, coupling is crucial. Commercially available servomotors are typically made with shafts of diameters that are designed to satisfy a great majority of applications, but are often inadequate for applications that require coupling to a relatively large mass load. Servomotors with a connection shaft also require a coupling method that leads to problems such as with misalignment, and resonance. Currently available hollow-shaft servomotors address some of these problems by rigidly attaching the rotor of the motor to the shaft, but such motors still lack the desired range of profiling.

Another shortcoming in the prior art is that typical servo control systems enable the control of multiple axes of motion, but generally limit each axis to one motor and feedback device. In some cases this is acceptable; however, when multiple motors are mechanically coupled together and need to be commanded in unison, these systems experience problems. For example, when separate axes of a controller are connected mechanically together, the motors tend to fight each other due to differences in the feedback error readings. In order to lessen this problem, systems may be detuned, but this results in inadequate control, response and performance.

As a result of these shortcomings in the art, there exists a need for an apparatus and method for accurately controlling large masses under high acceleration and deceleration profiles to provide a more flexible machine. In particular, a device for efficiently precisely controlling the movement or a large mass where frequent acceleration and deceleration occur is desired.

### SUMMARY OF THE INVENTION

The present invention provides a novel and improved control mechanism for efficiently controlling movement of loads in large mass processing equipment, such as paper converting machinery, where frequent acceleration and deceleration of the load occurs and precise positioning is desired. The control mechanism includes a frame, such as a plate, which supports a main gear and a plurality of servomotors. Each of the servomotors is provided with a drive gear and a feedback device. Each of the drive gears is mounted for engagement with the main gear. For example, the respective drive gears of the servomotors are meshed with the main gear such that the drive gears drive the main gear. The drive gears and the main gear are also preferably configured to reduce or eliminate backlash. The main gear may take the form of a center gear to which the drive gears are radially engaged, or a circumferential gear with the drive gears engaged therein. A relatively large mass load, such as a knife roll of a paper converting machine, may be coupled to and moved by force transmitted from the main gear, which is driven by the drive gears. Alternatively, the large mass load can be operatively connected with and moved by a force transmitted by each of the individual drive gears. In either event, no single servomotor supplies the entire force for driving the load.

A controller system comprising one or more motion controllers and one or more motor drives is provided. The controller system is adapted to transmit signals, such as torque command signals and commutation control signals, for example, to each of the servomotors. Preferably, each servo motor is coupled to a respective controller to receive command signals therefrom.

Preferably, the controller system is arranged to receive a plurality of feedback signals from different sources associated with the large mass load so as to produce a master feedback signal to each of a plurality of servomotors. The master feedback signal can be provided in a number of ways. A master feedback device such as a servomotor controller may be provided to generate a master feedback signal based on feedback information received from feedback devices associated with each of the individual servomotors. For example, the master feedback can receive a feedback signal from each of the servomotor feedback devices and derive a master feedback signal therefrom, such as by averaging or otherwise manipulating feedback signals from each of the feedback devices. Alternatively, one of the plurality of servomotor feedback devices can serve as the master feedback device such that the signal received by the controller is provided by a single feedback device. The controller responds to that signal by sending feedback signals to the servomotors.

Two preferred embodiments are described hereinbelow. In the first embodiment, a plurality of servomotors, each having a drive gear, is placed radially about a main or center gear. The motors are preferably of a hollow or thru-shaft construction enabling the connection to the load to have as large a diameter as possible to match the mechanical characteristics of the system. The feedback device for each servomotor references the position of the rotor. Each of the drive gears is meshed with the main or center gear, which also serves to eliminate or greatly reduce backlash. The main gear is driven by the drive gears engaged with it, and the main gear in turn transmits a force to move the load. In other words, the plurality of servomotors drive the center gear, which in turn drives the load. As such, no single servomotor is burdened with the movement of the entire load.

In a second embodiment, the servomotors with drive gears are again positioned about and mutually meshed with a center or main gear. In this embodiment, the main gear provides a timing and anti-backlash feature, but is not connected directly to the load. Rather, each of the drive gears is connected to a common drive shaft. Each of the drive shafts are, in turn, connected to and move the load in response to the respective drive gears.

In either embodiment, the main gear may optionally include a servomotor and a feedback device. The number of servomotors with drive gears that are engaged with the main gear may be varied as desired.

### BRIEF DESCRIPTION OF THE DRAWINGS

In the drawings:

FIG. 1 is a schematic front elevation view of the gear and motor side of a preferred embodiment of the control mechanism of the present invention;

FIG. 2 is a schematic side elevation view of the control mechanism of FIG. 1;

FIG. 3 is a schematic front elevation view of an embodiment of the load side of the control mechanism of FIG. 1 with a rotational load;

FIG. 4 is a schematic front elevation view of an alternative embodiment of the load side wherein the load includes a mass translated by a rack and pinion arrangement;

FIG. 5 is a schematic side elevation view of an alternate embodiment of a control mechanism according to the present invention;

FIG. 6 is a schematic side elevation view of a plate and load suitable for use with the control mechanism of FIG. 5;

FIG. 7 is a schematic side elevation view of a load combination of a rotary knife and anvil drum geared together;

FIG. 8 is a schematic side elevation view of a load combination of a rotary knife and anvil drum geared together and including a vacuum device incorporated on the anvil drum;

FIG. 9 is a schematic side elevation view of a load combination of a rotary knife with a stationary anvil;

FIG. 10 is a schematic side elevation view of a load combination of a stationary anvil and a rotary knife having a vacuum device;

FIG. 11 is a schematic diagram showing a plurality of servomotors driving a large mass load, with a control system providing feedback control for the servomotors;

FIG. 12 is a schematic diagram showing a plurality of servomotors driving a large mass load with another control system providing feedback control for the servomotors; and

FIG. 13 is a schematic diagram showing a plurality of servomotors driving a large mass load with yet another control system providing feedback control for the servomotors.

### DESCRIPTION OF THE PREFERRED EMBODIMENTS

The invention disclosed herein is, of course, susceptible of embodiment in many different forms. Shown in the drawings and described herein below in detail are preferred embodiments of the invention. It is understood, however, that the present disclosure is an exemplification of the principles of the invention and does not limit the invention to the illustrated embodiments. For ease of description, converting equipment utilizing a control mechanism embodying the present invention is described herein below in its usual assembled position as shown in the accompanying drawings, and terms such as upper, lower, horizontal, longitudinal, etc., may be used herein with reference to this usual position. However, the converting equipment may be manufactured, transported, sold, or used in orientations other than that described and shown herein.

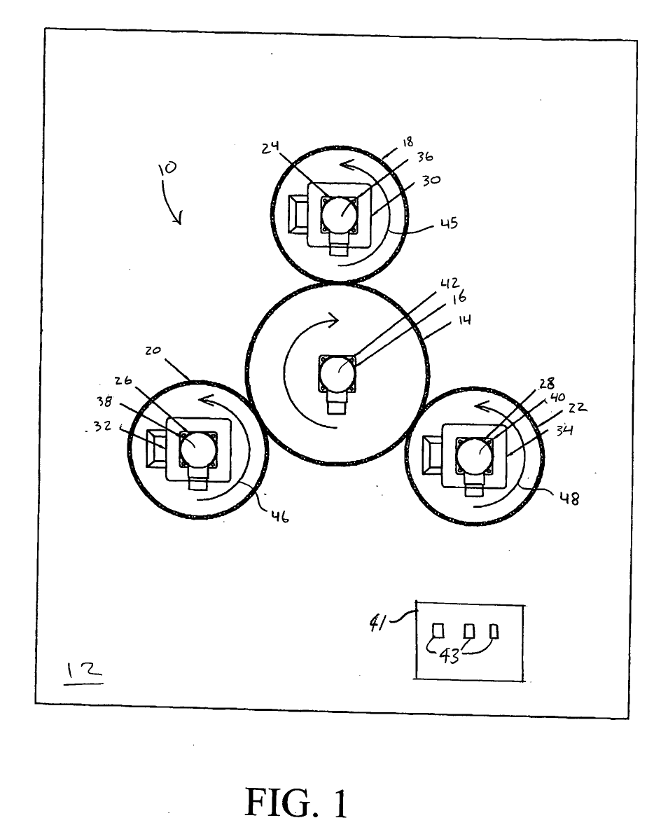

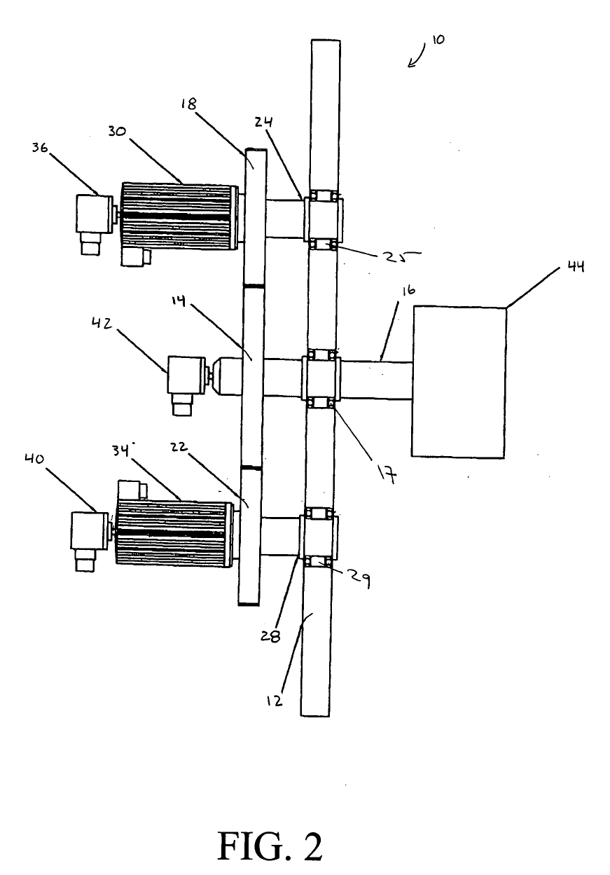

Referring to FIGS. 1 and 2, the converting equipment 10 embodying the present invention provides a frame, such as plate 12, a center gear 14 rotatably mounted to plate 12 and attached to shaft 16. Shaft 16 is journaled in plate 12 with journal bearings 17 so as to allow it to rotate. A plurality of drive gears 18, 20 and 22 are mounted radially around main or center gear 14. Gears 18, 20 and 22 are meshed with main or center gear 14 in a manner so as to reduce or eliminate backlash. The drive gears 18, 20, and 22 are configured to rotate in the same direction as indicated in FIG. 1, thereby causing the center gear 14 to rotate in an opposite direction.

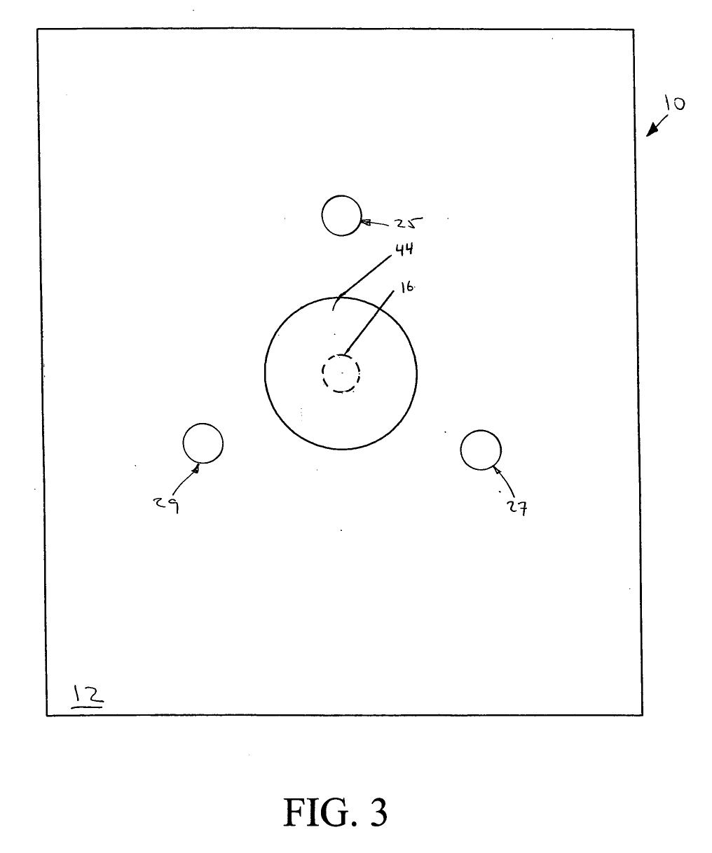

Drive gears 18, 20 and 22 are each fixedly mounted to a shaft. In particular, shafts 24, 26, and 28 are integral with gears 18, 20 and 22, respectively. Shafts 24, 26, and 28 are journaled in plate 12 with respective bearings 25, 27, (FIG. 3) and 29 and do not protrude through to the opposite side of the plate 12. Servomotors 30, 32, and 34 with respective shafts 24, 26, or 28, are mounted for driving respective drive gears 18, 20, or 22. One example of a suitable motor includes Kollmorgen Frameless Motors. A torque about shafts 24, 26, and 28, such as shown by arrows 45, 46, and 48 (FIG. 1) results in a relatively higher torque about shaft 16 according to the gear reduction and the number of drive gears and motors placed about the main or center gear 14. Although only three gears and motors are shown, any number of gears and motors may be used depending on the intended application. In other words, the number and reduction ratio of the motor and gears placed about the center gear 14 depends on the requirements of torque, speed and acceleration of the application. In applications with a larger mass load, additional gears and motors can be placed about the center gear. It should also be appreciated that other gears, such as and outer gear within which drive gears are mounted, are also suitable in place of the center gear.

In order to provide feedback for controlling the position, velocity and acceleration of the drive gears 18, 20 and 22 and shafts 24, 26, and 28, each of servomotors 30, 32, and 34 includes a feedback device 36, 38 and 40 such as an encoder. The servomotors 30, 32 and 34 and the feedback devices 36, 38 and 40 are operatively connected to a controller system 41 (see FIG. 1). Controller system 41 processes the inputted feedback signals and generates command or drive signals which are sent to the servomotors 30, 32 and 34, to control their operation. Control system 41 may be comprised of one or more individual motion controllers 43. The motion controllers may be connected to a respective servomotor or a single motion controller can provide a common input signal to each of the servomotors. One example of a motion controller that is suitable for the present invention is the eXMP manufactured by Motion Engineering, Inc. Control system 41 can also include motor drive units of a known type.

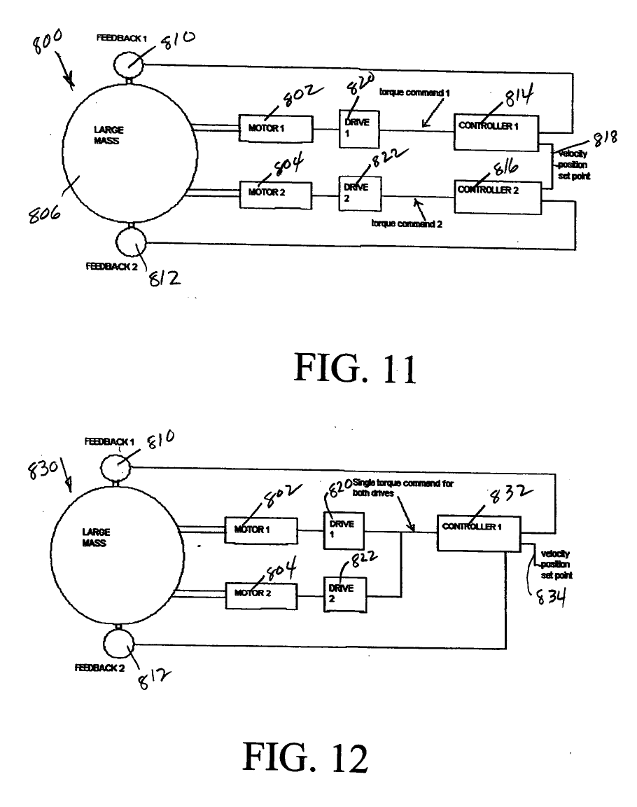

Referring to FIG. 11 equipment 800 is of a known type and includes servomotors 802, 804 which together drive a large mass load 806. Feedback devices 810, 812 are fed to respective controllers 814, 816. A velocity position signal set point is inputted at 818 to the controllers 814, 816. Output signals from controllers 814, 816 are coupled to servomotors 802, 804, through motor drives 820, 822, respectively. Controllers 814, 816 provide signals to motor drives 820, 822 which comprise torque commands for servomotors 802, 804. With the components of equipment 800 connected as shown in FIG. 11, it is been observed that the servomotors 802, 804 will fight or otherwise interact with one another in an undesirable manner. The problem arises from the inability of feedback devices 810, 812 to read velocity and position of the large mass load exactly the same, due, for example, to tolerances in the construction of the feedback devices. As a result, controllers 814, 816, having a normal proportional plus integral control, will output torque commands calling for different speeds and positions in response to the different values of the feedback devices 810, 812. Oftentimes, arrangements of the type shown in FIG. 11 are unworkable for practical purposes.

Referring now to FIG. 12, equipment 830 generally resembles equipment 800, except that the two controllers 814, 816 of equipment 800 have been replaced by a single controller 832 which provides a common output signal routed to both motor drives 820, 822. Thus, each motor drive receives the same torque command. As a result, the servomotors 802, 804 are made to produce the same torque and no longer fight or otherwise undesirably interact with one another. As illustrated in FIG. 12, two feedback devices 810, 812 provide respective feedback signals to controller 832 and a velocity position set point signal is inputted at 834. If desired, controller 832 can be adapted to ignore one of the feedback signals, or to process the two feedback signals in some predetermined manner, such as signal averaging, with or without signal weighting. As illustrated in the example shown in FIG. 12, it is generally preferable in many instances to produce one torque command serving as a common input to the servomotors connected to the same large mass load.

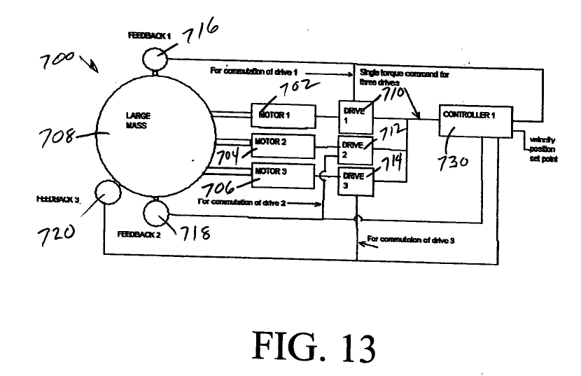

Referring to FIG. 13, equipment 700 includes servomotors 702, 704, 706 which cooperate to drive a large mass load 708. Motor drives 710, 712, and 714 are electrically coupled to provide control signals to the servomotors 702, 704, 706, respectively. Each of the motor drives has multiple inputs to receive signals from respective feedback devices 716, 718, and 720 as well as a common command signal outputted by controller 730. As can be seen in FIG. 13, controller 730 receives input signals from each of the feedback devices 716, 718 and 720. The output of controller 730 is fed to the motor drives 710, 712, and 714, as shown. In the embodiment illustrated in FIG. 13, motor drives 710, 712 and 714 process feedback signals from feedback devices 716, 718, and 720 only for the purpose of providing commutation control to the servomotors 702, 704, and 706. The motor drives 710, 712, and 714 process inputs from the controller for purposes other than commutation control, for example for torque command of the servomotors 702, 704, and 706. If desired, other servomotor operating parameters can be controlled by the cooperation of controller 730 and motor drives 710, 712, and 714. It can thus be seen that motor drives 710, 712, and 714 provide dual functionality, one for commutation control of the servomotors, and the other for aspects of motor control unrelated to commutation. The present invention also contemplates one or more control units combining the functionality of controller 730 and motor drives 710, 712, and 714, as may be expedient, for example for environmental considerations of the electronics involved.

Several of the possible variations will now be discussed. If desired, each motion controller could receive its own respective input from one of the feedback devices 36, 38 and 40, and sends in response thereto, a command or drive signal to a respective servomotor. Signals from one of the feedback devices could also be inputted to the motion controllers 43. Each motion controller could process the inputted feedback signal in a different fashion, as may be desired.

Referring again to FIGS. 1 and 2, feedback device 36 is utilized to determine the motor shaft velocity or revolutions per unit time, e.g., RPM, and motor shaft position of servomotor 30. The commands from the control system 41 for the resultant load are determined from information transmitted by feedback device 36. The controller, however, is suitable for commanding the movement of servomotors 32 and 34, as well as to provide the same values of torque and direction. For example, in the case of AC servomotors, the control command is delivered by means of commutation. This unique and novel control mechanism enables multiple servomotors to be mechanically connected to work together in unison.

Shaft 16 is connected to and moves load 44 by transmitting the force from drive gears 18, 20 and 22 through center gear 14. Examples of loads include knife rolls or folding rolls, or other devices requiring profiling. Since the resultant motions of shafts 24, 26, and 28 are transmitted via gears 18, 20 and 22 to center gear 14, a feedback device 42 communicating with control system 41 may be included for monitoring position and RPM of shaft 16. Alternatively, feedback devices 36, 38 and 40 can be averaged and used for shaft position and shaft velocity commands. Yet another method for providing feedback is to preselect any one of feedback devices 36, 38, 40 and 42, and use the predetermined feedback device for position and RPM commands to the resulting load.

Since the load is driven by a plurality of servomotors, the required torque is provided without increasing the mass of the servomotors themselves, which would otherwise result in the aforementioned drawbacks. The consolidation of the feedback from the plurality of feedback devices in the form of a master feedback signal enables the servomotors to work in unison to controllably drive the load.

Referring to FIG. 3, a load 44 is shown as a rotational mass connected to shaft 16 of main gear 14 through plate 12. For example, load 44 may be a knife roll or an anvil roll. As discussed above, with the knife roll example, the linear surface speed of the load 44 may be adjusted by increasing or decreasing the overall torque applied by the plurality of servomotors. In so doing, the surface speed of the knife roll is adjusted to accommodate different cutoff lengths, without the need to replace components, and thereby decreasing downtime. Such adjustments to the profiling may also be used in printing press applications requiring adjustments to the registry of the print cylinders.

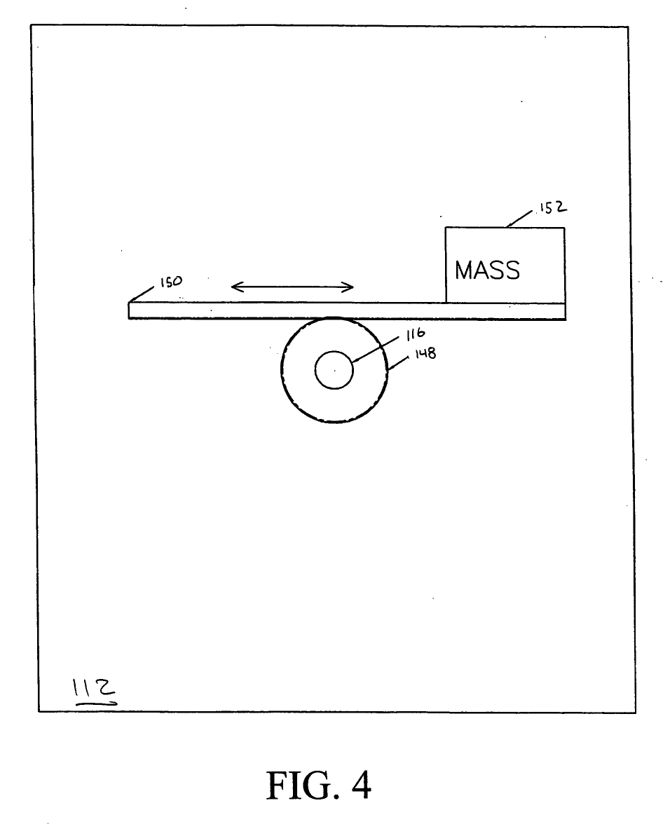

An alternative load is shown in FIG. 4. In this embodiment, the servomotors, drive gears and main gear are similar to that described above. A shaft 116 protrudes through plate 112 and is connected to gear 148, which drives rack 150 in a rack and pinion arrangement. A mass 152 is therefore translated linearly by a rotational motion of gear 148.

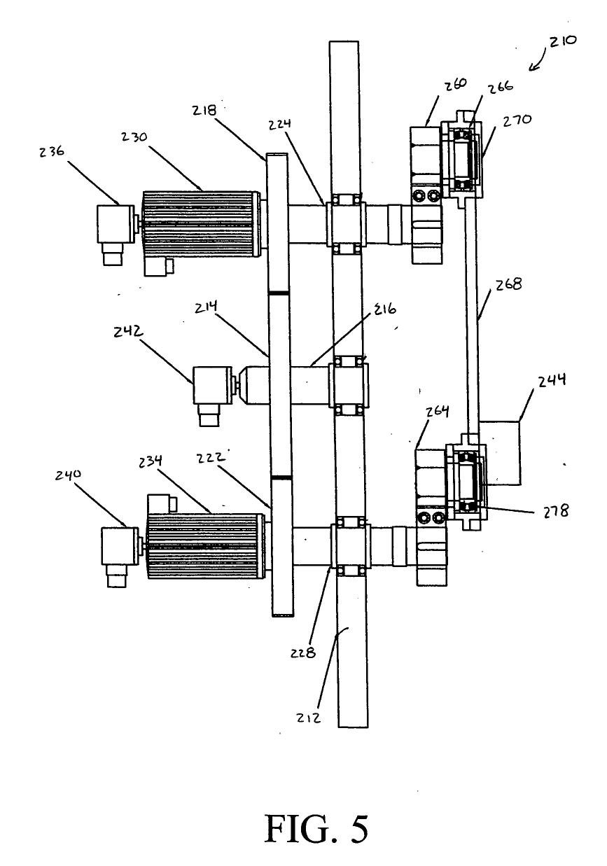

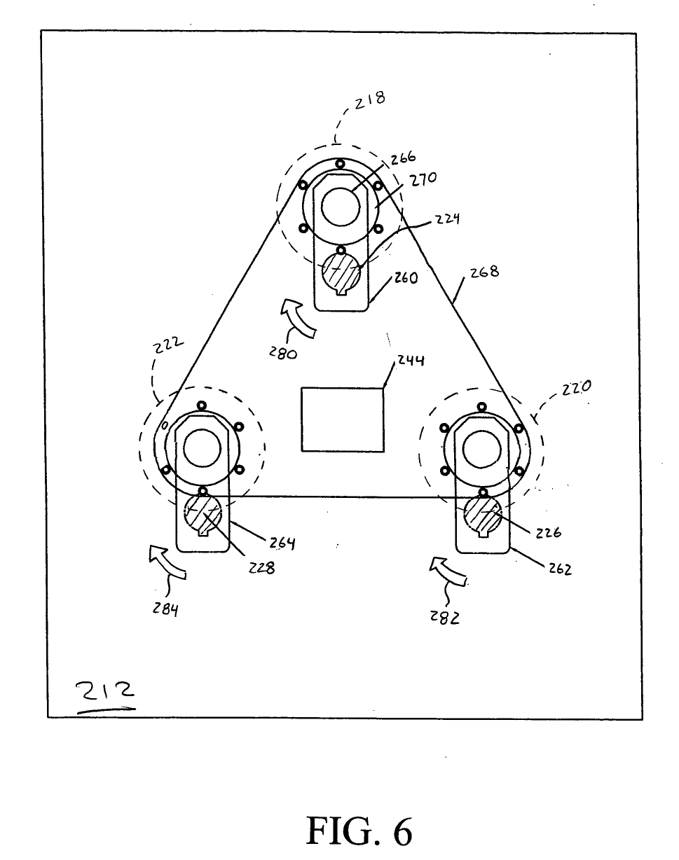

Referring to FIGS. 5 and 6, an alternative embodiment of the present invention is shown. In this embodiment, the arrangement of the servomotors, gears, and shafts are similar to the previous embodiment. The converting equipment 210 includes a plate 212, a center gear 214 attached to shaft 216. Shaft 216 is mounted on plate 212, and a plurality of drive gears such as drive gears 218, 220 (FIG. 6 in phantom) and 222 mounted radially around and meshed with main gear 214. Shafts 224, 226 and 228, which are connected with gears 218, 220 and 222, are also mounted to plate 212. Servomotors 230 and 234, which are rigidly connected with shafts 224 and 228, respectively, drive their respective drive gear 218 and 222. Drive gear 220 is also driven by a shaft servomotor rigidly connect to a shaft. As before, respective feedback devices for each of the servomotors, such as feedback devices 236 and 240 are provided.

Unlike the previous embodiment, shaft 216 does not protrude through plate 212, such that it operates to drive a load. Instead, referring also to FIG. 6, shafts 224, 226, and 228 protrude through plate 212 and are connected to arms 260, 262 and 264, respectively. For example, arm 260 is rigidly coupled to shaft 224. Arm 260 extends through bearing 266, and is journaled in a plate 268 using bearing 266 and bearing housing 270. Arms 262 and 264 are similarly journaled in plate 268 through bearing housings 276 and 278. With this configuration, each of the servomotors transmits torque to a load 244 attached to plate 268. Combining an assembly of servomotors to a common plate 268 results in an orbital type motion in which plate 268 and load 244 travel a circular path while maintaining a fixed orientation relative to one another. In other words, arms 260, 262 and 264 move in unison as shown by arrows 280, 282 and 284 such that plate 268 and load 244 travel a circular path, but do not rotate relative to the plate 212. An example of a suitable mass for this embodiment is a rotating blade assembly used to cut longitudinal lengths of wiper products or the like.

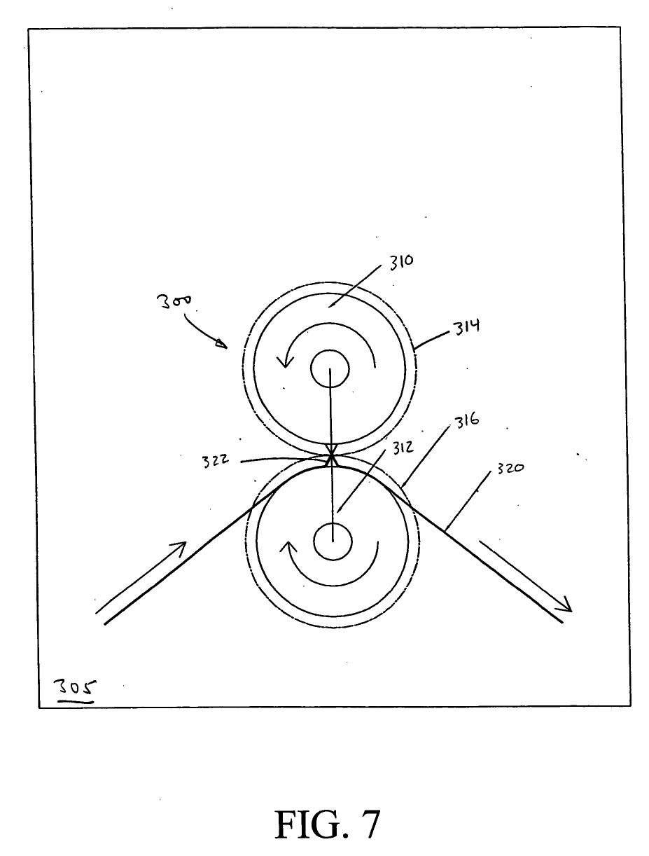

Many applications for the control mechanism of the present invention will be readily apparent to those skilled in the art. One example shown in FIG. 7 is suitable for the embodiment of the control mechanism shown in FIGS. 5 and 6. A two roll rotary knife combination 300 mounted to plate 305 is shown in which a knife roll 310 and an anvil roll 312 are driven by the device of FIGS. 1-3. Knife roll 310 is connected to gear 314, which is meshed with gear 316 that drives anvil roll 312. Gear 314 is driven by force transmitted by main gear 313. In this example, gears 314 and 316 are geared in a 1:1 ratio. A web 320 is laid across anvil roll 312 and is cut by blade 322 of knife roll 310 when blade 322 contacts the web 320.

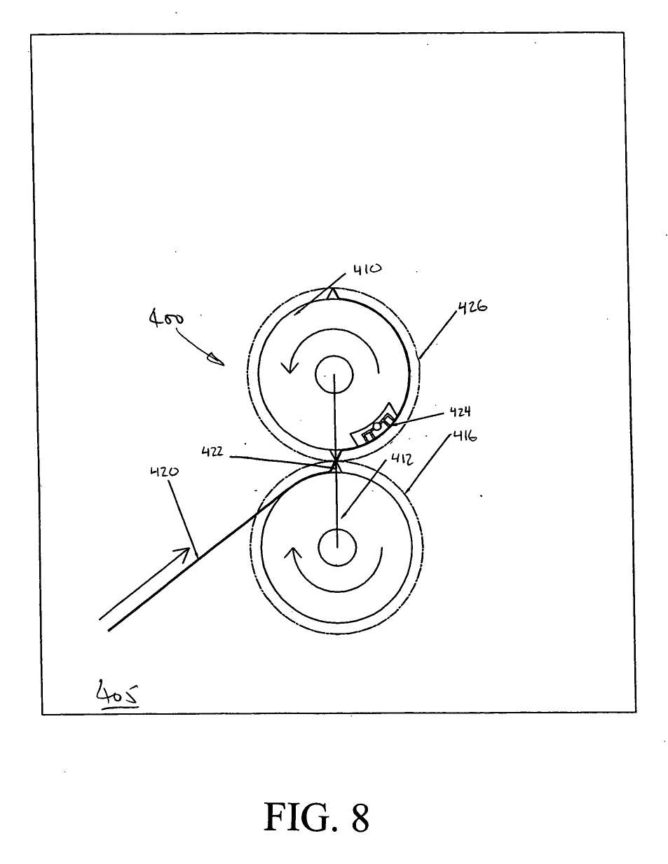

FIG. 8 illustrates a two roll rotary knife combination 400 mounted to plate 405 and including a knife roll 410 and an anvil roll 412. As before, knife roll 410 is connected to gear 414, which is meshed with gear 416 that drives anvil roll 412. A web 420 is fed between the rolls and cut by blade 422. In this embodiment, a vacuum chamber 424 is included in the knife roll 410, which holds the clean-cut sheet 426 to roll 410 until a transfer to another roll or process is needed.

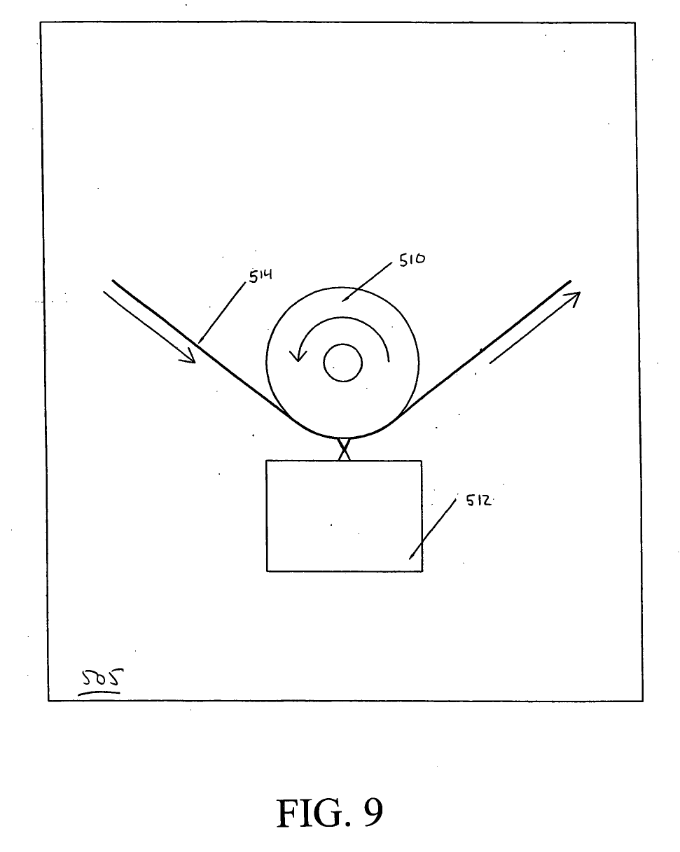

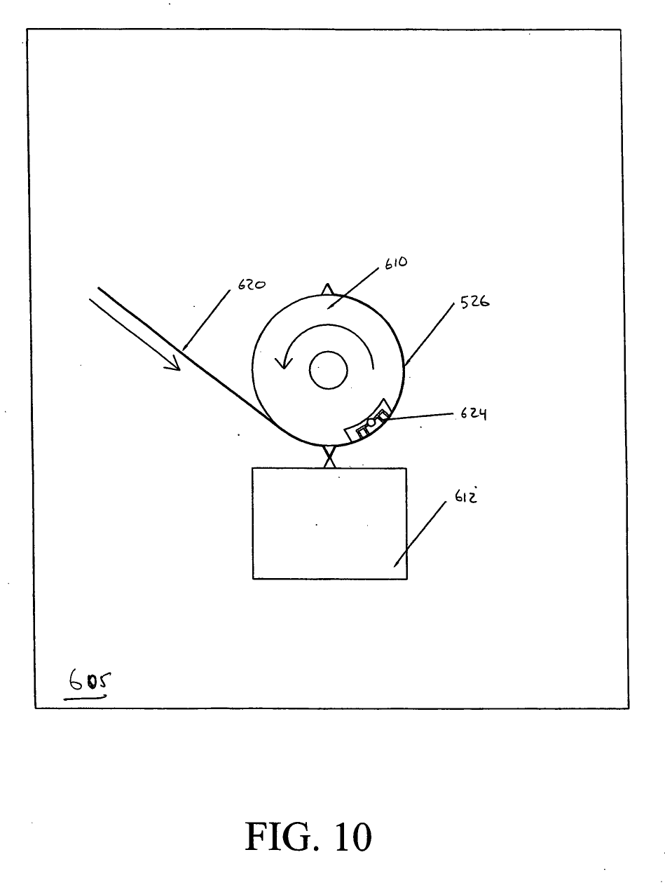

FIG. 9 illustrates a single rotating knife 510 mounted to plate 505 that cooperates with perforator head 512 to perforate the web 514. FIG. 10 illustrates knife roll 610 mounted to plate 605 and having a vacuum chamber 624. Web 620 is perforated by perforator head 612 and sheet 626 is held in place by vacuum chamber 624 until a transfer to another roll or process is needed.

The foregoing description and the accompanying drawings are illustrative of the present invention. Still other variations and arrangements of parts are possible without departing from the spirit and scope of this invention.

We claim:

1. A control mechanism for manipulating movement of large mass processing equipment, the control mechanism comprising:
a frame;
a main gear supported by the frame;
a plurality of servomotors, each servomotor adapted to drive a shaft rigidly connected with a drive gear and further including a servomotor feedback device that references the motion of the shaft;
each drive gear being meshed with the main gear so that movement of the drive gear drives the main gear, each drive gear operatively connected with a load such that each drive gear is adapted to transmit a force to move the load; and
a controller operably connected to each of the servomotors and suitable for receiving a predetermined feedback signal and transmitting command signals to each of the servomotors.

2. The control mechanism of claim 1, wherein each said drive gear moves the same load.

3. The control mechanism of claim 1, wherein the main gear is a center gear and each said drive gear is radially mounted for engagement with the center gear.

4. The control mechanism of claim 1, wherein the predetermined feedback signal is generated by a master feedback device.

5. The control mechanism of claim 4, wherein the master feedback device receives a feedback signal from each said servomotor feedback device.

6. The control mechanism of claim 4, wherein the master feedback device is one of said servomotor feedback devices.

7. The control mechanism of claim 4, wherein the predetermined feedback signal is generated by the master feedback device averaging feedback signals from each of the servomotor feedback devices.

8. A method for efficiently controlling movement of relatively large mass in a processing equipment, the method comprising:
transmitting to a controller a feedback signal from feedback devices associated with a plurality of servomotors having a drive gear so that rotation of the drive gear drives the main gear;
generating a master control signal based upon a received feedback signal; and
transmitting the generated master control signal from the controller to each of the plurality of servomotors.

9. The method of claim 8, wherein the master control signal is generated by a predetermined feedback device.

10. The method of claim 9, wherein the predetermined feedback device generates a signal derived from a feedback signal from each servomotor.

11. The method of claim 9, wherein the predetermined feedback device is a servomotor feedback device.

12. The method of claim 9, wherein generating the master feedback signal is obtained by averaging feedback signals from each of the servomotor feedback devices.

13. A control mechanism for manipulating the acceleration of a large mass load, the control device comprising:
a frame supporting a main gear and a plurality of drive gears wherein the plurality of drive gears are mounted for engagement with the main gear;
each of the plurality of drive gears is operatively connected to a servomotor; and
a controller adapted to receive a predetermined feedback signal from at least one of the plurality of servomotors and to transmit a control signal to each of the plurality of servomotors.

14. The control mechanism of claim 13, wherein the predetermined feedback signal comprises an average of feedback signals from each of the plurality of servomotor feedback devices.

15. The control device of claim 13, wherein the predetermined feedback signal is generated by one of the plurality of servomotor feedback devices.
